(19) United States
(12) Patent Application Publication
(10) Pub. No.: US 2010/0275797 A1
(43) Pub. Date: Nov. 4, 2010

(54) CUSTOM WALLPAPER SYSTEMS AND METHODS

(76) Inventors: Gabriel J. Cortina, Camarillo, CA (US); John Jedziniak, Mission Viejo, CA (US)

Correspondence Address: AVERY DENNISON CORPORATION;Patent Group, Law Department - 3 South, P.O. BOX 7090, PASADENA, CA, 91109-7090, US

(21) Appl. No.: 12/763,080

(22) Filed: Apr. 19, 2010

Related U.S. Application Data
(60) Provisional application No. 61/174,836, filed on May 1, 2009.

(51) Int. Cl. B41F 1/54; G06K 15/00

(52) U.S. Cl. 101/484; 358/1.18

(57) ABSTRACT

A method for creating digital images, including the following: receiving a design including a plurality of constituent shapes, extracting each constituent shape from the design as an individual shape that is independent of the other constituent shapes, and creating a digital file for each extracted constituent shape that contains information describing the respective extracted constituent shape.

### CROSS-REFERENCE TO RELATED APPLICATION

Priority is claimed to U.S. Provisional Patent Application No. 61/174,836, filed on May 1, 2009, entitled “Custom Wallpaper Systems And Methods,” by Gabriel J. Cortina and John Jedziniak, which application is incorporated by reference herein.

### TECHNICAL FIELD

This disclosure relates to customized wallpaper, and to systems and methods for allowing customers to select a particular wallpaper design from a displayed selection, and to customize the design by modifying the selected design and/or by adding personalized information to the selected design.

### BACKGROUND

Among the variety of ways of decorating walls in both dwellings and commercial enterprises is the use of wall coverings, particularly wallpaper. The term “wallpaper” generally refers to rolls of sheets of a substrate onto which is printed a design. The substrate is not limited to paper, but can be any other type of sheet onto which print can be applied, and that will adhere to a wall surface, such as vinyl sheeting.

While wallpaper sometimes provides a better aesthetic appearance than paint, wallpaper decorations can be limited by the repeating patterns that are required to allow alignment of similarly patterned sheets of wallpaper side by side on a wall. Wallpaper decorations are also typically limited to the designs offered by any one particular manufacturer of wallpaper.

What is needed is a method and apparatus for creating wallpaper that can be adapted for use on walls of different sizes and shapes or boundaries. Desirably, the wallpaper would also allow a purchaser to customize the designs further by adding personal detailed touches, such as custom images, text, and the like. It is further desirable that the customer should be able to select the wallpaper from a display, perform custom modifications, and receive the specially prepared wallpaper within a short space of time. The embodiments of the present disclosure answer these and other needs.

### SUMMARY

In a first embodiment disclosed herein, a method for producing wallpaper comprises receiving a design including a plurality of constituent shapes; extracting each constituent shape from the design as an individual shape that is independent of the other constituent shapes; presenting the design for selection by a user; upon selection of the design by a user, allowing the user to modify the design by modifying each extracted individual shape independently of the other extracted individual shapes comprising the design, to thereby produce a customized design; receiving custom order information from the user relating the customized design to a wall surface selected by the user; preparing printing instructions to print the modified design based upon the custom order information; and presenting the printing instructions to a printer to print wallpaper displaying the modified design and configured to cover the selected wall surface in accordance with the custom order information.

In another embodiment disclosed herein, a system for producing wallpaper comprises a first device connected to a communications network to receive a design including a plurality of constituent shapes and to extract each constituent shape from the design as an individual shape that is independent of the other constituent shapes; a second device connected to the communications network to present the design for selection by a user at a remote terminal connected to the communications network; upon selection of the design by a user, to allow the user to modify the design by modifying each extracted individual shape independently of the other extracted individual shapes comprising the design, to thereby produce a customized design; and to receive custom order information from the user relating the customized design to a wall surface selected by the user; and a third device connected to the communications network to prepare printing instructions to print the modified design based upon the custom order information and to transmit the printing instructions over the communications network to a printer to print wallpaper displaying the modified design and configured to cover the selected wall surface in accordance with the custom order information.

In a further embodiment disclosed herein, a method for creating digital images comprises receiving a design including a plurality of constituent shapes; extracting each constituent shape from the design as an individual shape that is independent of the other constituent shapes; and creating a digital file for each extracted constituent shape that contains information describing the respective extracted constituent shape.

These and other features and advantages will become further apparent from the detailed description and accompanying figures that follow. In the figures and description, numerals indicate the various features, like numerals referring to like features throughout both the drawings and the description.

### BRIEF DESCRIPTION OF THE DRAWINGS

FIG. 1 is a diagram of a networked system according to the present disclosure;

FIG. 2 is a diagram of a design that may be used with the present disclosure;

FIG. 3 is a flowchart of a method according to the present disclosure; and

FIG. 4 is a flowchart of another method according to the present disclosure.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

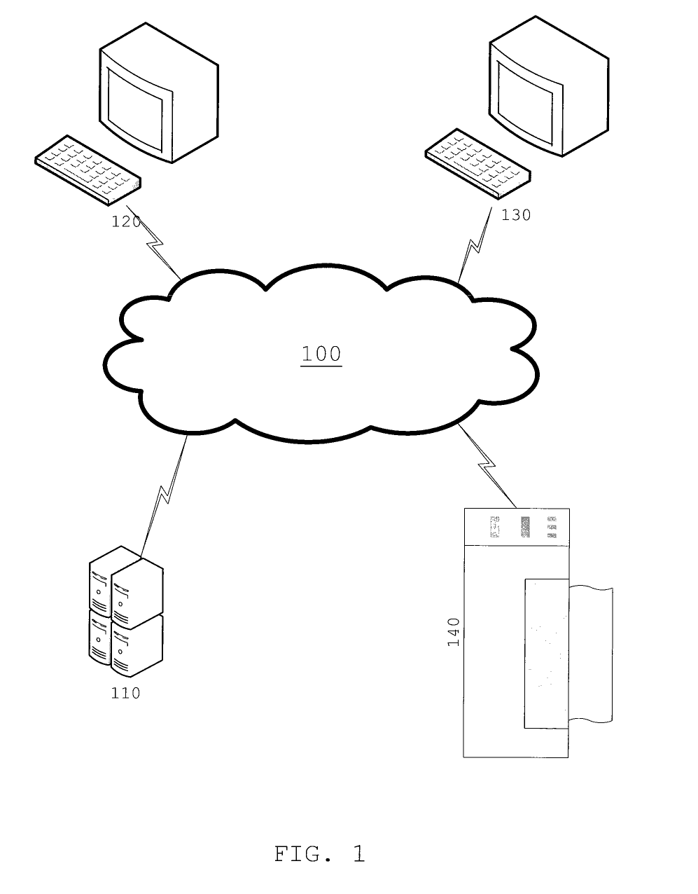

Referring to FIG. 1, an embodiment of a system envisioned by the present application is centered around a main server 110 that is connected to a network 100 (which in most practical applications is envisioned as being the World Wide Web or Internet). The main server is configured to interface with at least three other types of devices that are also connected to the network (only one of each such device is shown for clarity): a designer terminal 120, a user terminal 130, and a printing facility 140.

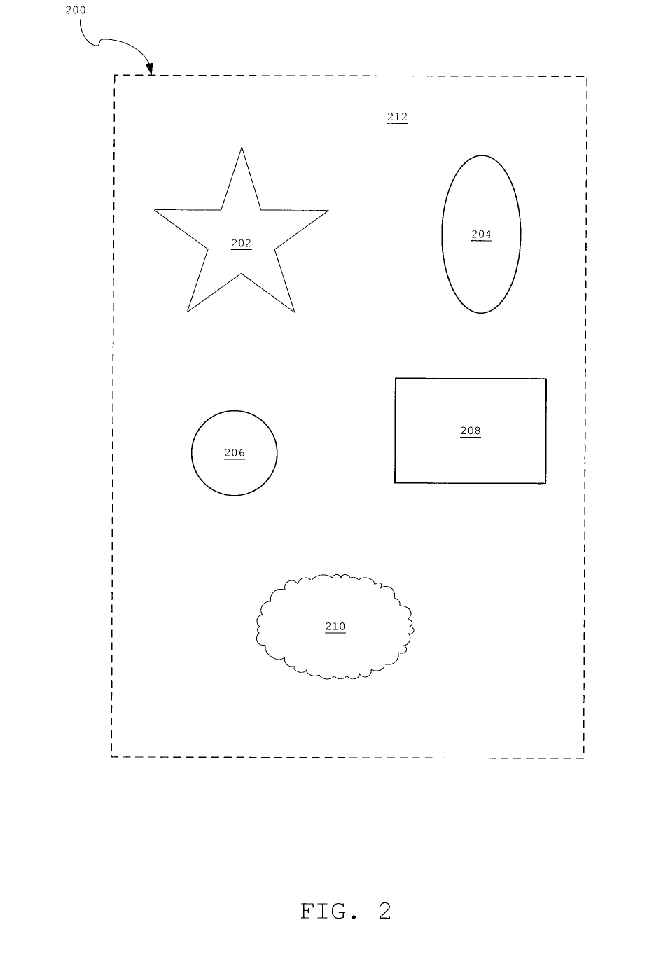

The main server 100 is configured to receive designs such as design 200 shown in FIG. 2 from designer terminal 120. These designs are received as digital files and the particular file type in which the file is provided by the designer terminal is irrelevant to the novel concepts disclosed herein. Preferably, however, the design files are encoded as vector or raster image files, such as, e.g., EPS, ODG, CGM, SVG, XPS, PDF, SWF, WMF, EMF, VSD, Al, DRW, DXF, PS, INDD, QXD, QXP, GIF, TIFF, JPEG, PNG, PSD, PSP, TEM, RAW, BMP, etc. Design 200 will typically include a number of constituent shapes (202, 204, 206, 208, 210) overlying a background 212. The constituent shapes shown are for illustration purposes only and their characteristics and relation to each other and the overall design are intended to convey no limitation whatsoever upon the novel concepts presented herein.

In accordance with the present disclosure, upon receipt of a design such as design 200 at the main server 110, the design may be decomposed by extracting each individual constituent shape (202, 204, 206, 208, 210) from the overall design such that each extracted individual shape can be manipulated independently of all other extracted individual shapes as well as of the overall design. From a computer programming perspective, this extraction process may produce a number of digital files, one file describing each extracted individual shape and one file describing the overall design. Thus, in one embodiment, each extracted individual shape file may contain data defining the relative size, aspect ratio, relative rotation, fill color, fill pattern, border color, border style, and border size of the respective individual shape. The overall design file may define the background, and the relationship of each constituent shape to all other shapes as well as to the borders of the design itself, and may typically be in the form of an XML file. The decomposition process may be performed automatically such as by a software process executing on the main server, or it may include the input of an operator (i.e. a person).

After the decomposition process is performed, the extracted individual shape files and the respective overall design file will typically be stored by the main server for future use. It is envisioned that the main server would store a plurality of different designs that have undergone the decomposition process, each design saved as a plurality of extracted individual shape digital files and a respective overall design (i.e. template) digital file.

In a process separate and distinct from the design decomposition process detailed above, a user may log on to the main server 110 through a user terminal 130, which accesses the main server through the network 100. The user terminal would typically be a personal computer in the user's home with an Internet connection such as via DSL or cable. The main server may be configured to present the plurality of designs stored thereon to the user for selection thereby, such as via a webpage that the user may access on his user terminal. The main server may also be configured to assist the user in selecting a design; in this embodiment each overall design file may include text tags describing the overall design (background color, background pattern, etc.) and the constituent shapes (stars, moons, animals, clouds, etc.) and the main server may allow the user to search these tags to identify designs containing elements of interest.

Upon selecting a particular design, the main server will further allow the user to customize the selected design, such as by example modifying each constituent shape independently of the other constituent shapes and of the overall design, modifying the overall design, and creating a repeating pattern based upon the overall design. Each constituent shape may be modified by, inter alia, modifying its relative size, aspect ratio, relative rotation, fill color, fill pattern, border color, border style, border size, and shadowing. Each overall design may be modified by, inter alia, modifying the relative locations of the constituent shapes, the background color(s), the background pattern(s), and the borders of the design.

The main server may allow a user to further customize a selected design by adding personal information, such as pictures, shapes, designs, colors, patterns, borders, and text. Upon uploading or entering such information, the main server may allow the user to manipulate each individual piece of personal information with respect to the selected design in the same manner that it allow manipulation and modification of the individual constituent shapes. The main server may also store any one or more variations of a design as modified by a user for later retrieval and optionally further modification by the user.

In a preferred embodiment, the main server is configured to display a virtual space to the user, such as a virtual room, to allow the user to customize the virtual room such as by specifying dimensions and features such as doors and windows, and to render the selected, customized design onto the virtual room walls to thereby provide a vision of how the selected modified design will look if applied to the user's walls. The main server may further allow the user to modify the design while it is rendered upon the walls of the virtual room to thereby instantly show the effect of each change by the user. Additional features may also be available for customizing the virtual room, such as furniture pieces, lighting fixtures, wall decor (such as paintings, sconces, shelving, and moulding), and lighting effects. Furthermore, the main server may include tools to assist the user in customizing the selected design, such as a randomize tool that may pick colors randomly from available color palettes and apply them to different elements of the design (e.g. the background, one or more constituent shapes, etc.), may randomly replace shapes in the design with other randomly selected shapes which may optionally be randomly selected from a pre-defined collection of related shapes or designs, may randomly change shape attributes such as relative position, rotation, size, etc., and may randomly generate patterns by using randomly selected pattern repetition methods and/or layouts. The virtual room and all of the user's modifications may also be saved by the main server for later retrieval and further modification by the user. The manipulation and display of virtual spaces is a well known and developed art and the technical details of practically implementing such a virtual space visualization routine are beyond the scope of this disclosure and irrelevant to the novelty of the concepts disclosed herein.

Once the user has modified a selected design to his satisfaction, the main server may allow him to order wallpaper printed with the customized design. The user would be allowed to input custom order information that includes the wall surface size and the wall surface shape. As such, the user would not be limited to ordering sheets of wallpaper that are intended to be applied adjacent to each other to cover an entire wall, as typical with currently-available off-the-shelf wallpaper. The user may choose a wall shape that may be formed with any outline, and order the modified design printed on wallpaper to cover the desired outline only. Thus, the user may specify an outline for the selected design that is a rectangle to conform to a certain wall, or may be a rectangle with interior cutouts that correspond to windows, doors, shelving, etc., or may be in the shape of a silhouette such as a person, animal, car, train, etc. As previously mentioned, the user may create a repeating pattern based on the modified design, or may scale the modified design so that only a single instance of the modified design is printed at a size sufficient to cover the selected wall surface and shape. The user may also be presented with various choices of printing media (cloth, silk, paper, vinyl, etc.) and various finish options (clear, matter, lustrous, etc.). The user may also be allowed to order a small sample to ensure that the physical product is satisfactory.

Upon the customer placing on order, the main server may produce a set of printing instructions in a format ready to be received and executed by printing facility 140. Producing the printing instructions may entail retrieving the overall design file (e.g. the XML template) and generating a printer-ready file such as a PDF file that takes into account all of the modification made by the user. The main server may next retrieve the file of each individual constituent shape, adjust the shape in accordance with the modifications made by the user, and place the shape on the appropriate page(s) of the PDF file to create the final overall design. A similar process may be performed for custom information entered by the user, which would typically also be stored as separate files. The printer instructions will be heavily dependent upon both the type of design and wallpaper ordered by the customer and the printer that will produce the final product. Continuing with the example of a PDF file, if the customer orders a design that is intended to be applied as a single instance of wall decor (e.g. a silhouette), two separate PDF files may be produced: one file defining the image/design to be printed along with any special printer alignment marks and project reference information, and a second file containing vector information to control a die-cutter machine that may be used to pre-cut the design for the user's benefit. The printed designs may be slightly enlarged to accommodate a bleed area to accommodate any die-cut inaccuracies. In another embodiment, if the customer orders a design that is intended to be applied as a mural covering the entire wall, a single, multi-page PDF file may be generated wherein each page contains a single panel and has been adjusted such that it has a predetermined overlap with adjacent panels. Panel information may be printed in the margins at the top of each panel. In one embodiment, the printer-ready files may be used to generate a new image file that may then be displayed to the user for a final quality check. The printing instructions will typically be generated by a raster image processor (RIP). A RIP is comprised of hardware, software, and/or firmware that converts pages described as a mixture of raster images, text, and vector graphics statements into raster graphic images or bitmaps which are understood by a specific printing device, and are well known in the art.

Multi-paneled murals may be overlaid with a simulated texture layer. Such texture layers may be applied to obscure banding effects that may appear on printed materials. The simulated textures may be provide a simulated cast shadow effect on the images and may be separate image layers that are blended over the designs using, e.g., PDF blend mode attributes. To minimize the color impact of the blending of the color layer, each element may have its own simulated texture layer blended above it that has been re-colored to a predefined coordinated color. For example, a design that has one yellow square, one red square, and a blue background, could have three texture layers. The background would have a blue-compatible colored texture applied, with cutouts for the yellow and red squares; the yellow square would have a yellow-compatible colored texture applied only for the area on the design of the yellow square; and the red square would have a red-compatible colored texture applied only for the area on the design of the red square.

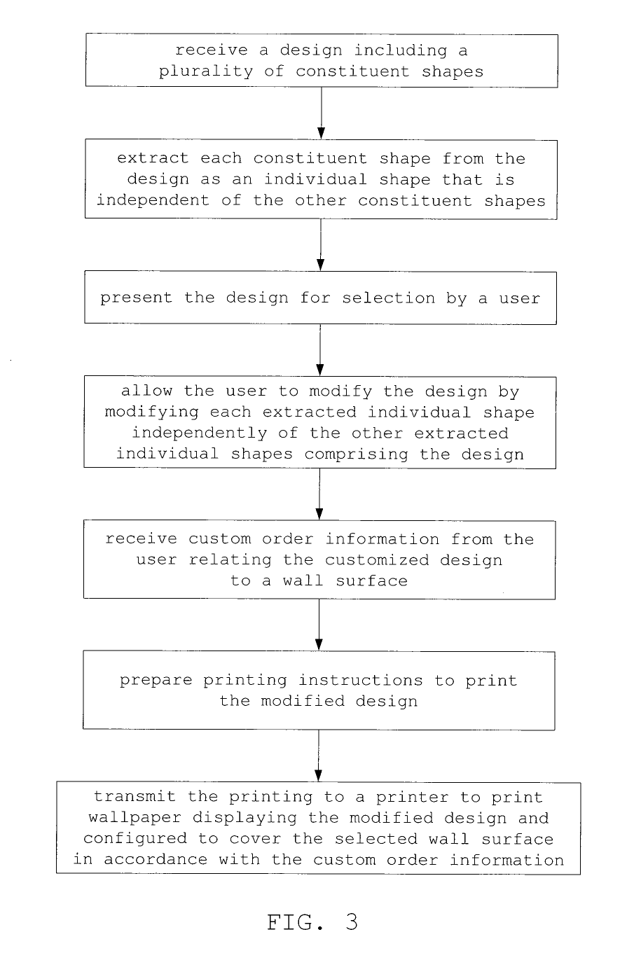

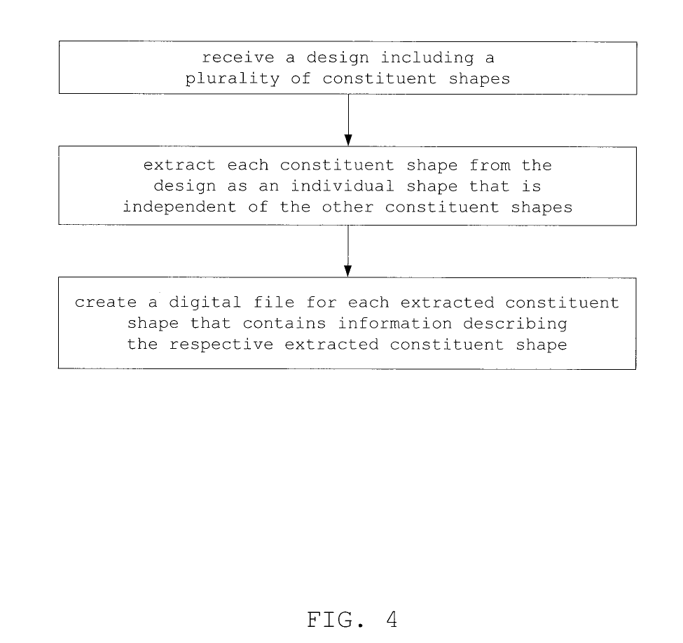

FIGS. 3 and 4 are flowcharts illustrating the processes described above.

In one embodiment of the present disclosure, the user may be given the option to include radio frequency identification (RFID) tags into each panel printed, or alternatively in only one panel printed. RFID tags, inlays and labels (collectively referred to herein as “devices”) are widely used to associate an object with an identification code. RFID devices generally have a combination of antenna(s) (a conductive pattern) and analog and/or digital electronics, which may include for example communications electronics, data memory, and control logic. For example, RFID tags are used in conjunction with security-locks in cars, for access control to buildings, and for tracking inventory and parcels. Some examples of RFID tags and labels appear in U.S. Pat. Nos. 6,107,920, 6,206,292, and 6,262,292, all of which are hereby incorporated by reference in their entireties in the present embodiment, the RFID(s) may include information identifying the design such as by a code or an order number, the manufacturer/printer of the wall paper, characteristics of the wallpaper such as material, use and care instructions, etc. In another embodiment, the wallpaper with RFID structure includes a base sheet, a cover sheet upon which a laser printer applied image is formed by passing the sheet assembly through a print path of a laser printer, and a mask sheet having at least one window. The sheets form a protective pocket within the window for protecting an electronic circuit from the heat and pressure applied by the laser printer when printing an image on the cover sheet. This structure is fully described in U.S. Pat. No. 6,851,617 which is hereby incorporated by reference in its entirety.

A useful feature of the novel concepts presented herein is that the system is a distributed system, the parts of which may be physically located anywhere on the globe. As such, the main server acts as a clearing house between the developers and providers of designs (typically graphic artists and stock photo depositories), end users, and printing facilities. The world-wide prevalence of the Internet makes it possible for the main server to be physically located in one location and to be accessed by design providers and users on any of the five continents, as well as forward printing instructions and order information to printing facilities similarly located on any of the five continents. In other embodiments a single customer order may be processed into multiple print jobs that are executed by multiple printing facilities. The various printing facilities may have different printing devices and the main server may thus prepare different printing instructions for each printing facility both in terms of the portion of the print data that is to be rendered to print media (i.e. the customized design to print onto wallpaper) as well as the printing device specific options.

It must be understood that the main server 110 is illustrated in the figures and referred to as a single entity for ease of reference and clarity only. The actual hardware, software, and/or firmware configuration of the main server is of no relevance to the practice of the novel concepts disclosed herein. As such, the functions performed by the main server as described herein may be divided amongst and performed by a plurality of hardware platforms that may be physically remote from one another and interconnected via the Internet or an intranet. For instance, a first hardware platform may be connected to the network to receive a design including a plurality of constituent shapes and to extract each constituent shape from the design as an individual shape that is independent of the other constituent shapes. A second hardware platform may be connected to the network to present the design for selection by a user at a remote terminal connected to the communications network and, upon selection of the design by a user, to allow the user to modify the design by modifying each extracted individual shape independently of the other extracted individual shapes comprising the design, to thereby produce a customized design; and to receive custom order information from the user relating the customized design to a wall surface selected by the user. Finally, a third hardware platform may be connected to the network to prepare printing instructions to print the modified design based upon the custom order information and to transmit the printing instructions over the network to a printing facility to print wallpaper displaying the modified design and configured to cover the selected wall surface in accordance with the custom order information.

The printing method used to print the wallpaper is also not relevant to the novel concepts disclosed herein and the present disclosure contemplates the use of any type of printer employing any type of printing technology that can be employed to deposit graphic designs provided in the from of a digital file onto wallpaper material. As such, a non-exhaustive list of contemplated printing technologies include liquid electrophotography, ink jet deposition, and laser printing. In one preferred embodiment the printing facility uses the Indigo Digital Printing Press available from Hewlett-Packard Company (Palo Alto, Calif., USA) with Electrolnk™ ink. A preferred electrographic printer for printing custom wallpaper includes an electrode array further comprising a plurality of row lines, a plurality of data lines perpendicular to the row lines, and a plurality of thin-film transistors having a source at the data lines, drain at electrodes of the array, and gates at the row lines; a processor for placing a voltage selected from at least a first and a second voltages on each of the plurality of data lines of the electrode array and for driving the row lines of the array; a first ink applicator for applying electrophoretic ink to the electrode array, the electrophoretic ink comprising charged particles in a liquid component; a development electrode charged to a third voltage for developing an image of charged ink particles; image transfer apparatus for transferring the image to a printing substrate; and ink removal apparatus for removing excess ink from the electrode array.

In another embodiment, the user may be presented with various filter or coating materials that may be applied to the finished wallpaper to select therebetween. However, if an image filtering material is applied to the wallpaper, the image quality would typically change. Additionally, when printing an image, artifacts, such as graininess and mottling, can become part of the printed image. If artifacts become part of the image, a low pass filter can be used to blur or smooth the presence of the artifacts.

An image filtering material including, but not limited to, low pass, high pass, or band pass filtering material, among others, can be used as part of an optical image filtering process. Additionally, the processing of an image can include using electronic image processing in connection with the optical image filtering process. This includes using a digital image processing technique, e.g. using low pass, high pass, or band pass digital processing, to adjust an image, among others, in connection with an image filtering material to provide photographic quality images. Images can be digitally transformed in a frequency domain and translated back into a spatial domain for printing, by use of software. Transforming in the frequency domain can include digitally sharpening an image at certain frequencies. That is, as used herein, sharpening an image is intended to mean increasing the amplitude of certain frequency components relating to the appearance of an image.

There are several ways that coatings can be applied to images as part of the optical image filtering process. For example, films of material can be added to the surface of print media having an adjusted image printed thereon. A transparent adhesive can be applied between the printed media, e.g. image, and a film to adhere the film to the print media. Adhesive can be applied to print media by spraying or painting and a film can be applied by a pressure roller. Embodiments of the invention, however, are not limited to these examples.

A low pass filtering material can be deposited over the image which changes the perception of the image when it is viewed due to the optical properties of the material. When a low pass filtering material coating is used, the image and the artifacts will appear blurred in comparison to uncoated image. Accordingly, an image can be first adjusted digitally with software to perform low pass, high pass, or band pass digital processing on the image. This adjustment can account for one or more image filtering material characteristics (i.e., characteristics of the coatings and/or adhesives) such that when the coatings/adhesives are applied, the image will appear as intended.

As one exemplary embodiment, a design image can be adjusted prior to printing such as, e.g., by using high pass digital processing, to sharpen the image prior to printing onto the wallpaper and then adding a coating or adhesive thereto. The image may be adjusted by utilizing, inter alia, a convolution filter. A convolution filter can be based on certain low pass filtering properties of a coating and/or adhesive that will be deposited over the printed image. In this manner, the design image is adjusted to take into account the effects of the coating and/or adhesive and produce an intended image quality once the coating and/or adhesive are applied. Those skilled in the art will appreciate that any form of image adjustment can be used within the various embodiments of the present disclosure.

The characteristics of the image filtering material and print media material may be known and used to hone a number of image characteristics. Examples of image material characteristics include thickness, clarity, index of refraction, surface roughness, and modulation transfer, to name a few.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a Claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No Claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . ” What is claimed is:

What is claimed is:

1. A method for producing wallpaper, comprising:
receiving a design including a plurality of constituent shapes;
extracting each constituent shape from the design as an individual shape that is independent of the other constituent shapes;
presenting the design for selection by a user;
upon selection of the design by a user, allowing the user to modify the design by modifying each extracted individual shape independently of the other extracted individual shapes comprising the design, to thereby produce a customized design;
receiving custom order information from the user relating the customized design to a wall surface selected by the user;
preparing printing instructions to print the modified design based upon the custom order information; and
presenting the printing instructions to a printer to print wallpaper displaying the modified design and configured to cover the selected wall surface in accordance with the custom order information.

2. The method of claim 1, wherein allowing the user to modify each individual shape comprises allowing the user to modify any one or more of the relative size, aspect ratio, relative rotation, fill color, fill pattern, border color, border style, border size, and shadowing of each individual shape.

3. The method of claim 1, wherein the custom order information includes any one or more of a wall surface size and a wall surface shape.

4. The method of claim 1, wherein allowing the user to modify the design comprises allowing the user to create a repeating pattern with the customized design.

5. The method of claim 1, wherein allowing the user to modify the design comprises allowing the user to add personalized information to the design.

6. The method of claim 5, wherein the personalized information includes any one or more of pictures, shapes, designs, colors, patterns, borders, and text.

7. A system for producing wallpaper, comprising:
a first device connected to a communications network to receive a design including a plurality of constituent shapes and to extract each constituent shape from the design as an individual shape that is independent of the other constituent shapes;
a second device connected to the communications network to present the design for selection by a user at a remote terminal connected to the communications network; upon selection of the design by a user, to allow the user to modify the design by modifying each extracted individual shape independently of the other extracted individual shapes comprising the design, to thereby produce a customized design; and to receive custom order information from the user relating the customized design to a wall surface selected by the user; and
a third device connected to the communications network to prepare printing instructions to print the modified design based upon the custom order information and to transmit the printing instructions over the communications network to a printer to print wallpaper displaying the modified design and configured to cover the selected wall surface in accordance with the custom order information.

8. The system of claim 7, wherein any two or more of the first, second, and third device are hosted on the same hardware platform.

9. The system of claim 7, wherein the second device is configured to allow the user to modify any one or more of the relative size, aspect ratio, relative rotation, fill color, fill pattern, border color, border style, border size, and shadowing of each individual shape.

10. The system of claim 7, wherein the custom order information includes any one or more of a wall surface size and a wall surface shape.

11. The system of claim 7, wherein the second device is configured to allow the user to create a repeating pattern with the customized design.

12. The system of claim 7, wherein the second device is configured to allow the user to add personalized information to the design.

13. The system of claim 12, wherein the personalized information includes any one or more of pictures, shapes, designs, colors, patterns, borders, and text.

14. The system of claim 7, wherein the communications network is the Internet.

15. The method of claim 1, wherein preparing printing instructions to print the modified design based upon the custom order information includes preparing instructions to guide a cutter to cut the modified design in accordance with the custom order information after the modified design has been printed.

16. The system of claim 7, wherein the third device is configured to prepare instructions to guide a cutter to cut the modified design in accordance with the custom order information after the modified design has been printed.

17. The method of claim 1, wherein modifying the design includes modifying the relative locations of the constituent shapes, the background color(s), the background pattern(s), and the borders of the design.

18. The system of claim 7 wherein the second device is configured to allow the user to modify any one or more of the relative locations of the constituent shapes, the background color(s), the background pattern(s), and the borders of the design.

19. A method for creating digital images, comprising:
receiving a design including a plurality of constituent shapes;
extracting each constituent shape from the design as an individual shape that is independent of the other constituent shapes; and
creating a digital file for each extracted constituent shape that contains information describing the respective extracted constituent shape.

20. The method of claim 19, wherein each digital file contains any one or more of vector and raster information describing the respective extracted constituent shape.

21. The method of claim 19, further comprising creating a template digital file that contains information describing the design.

22. The method of claim 21, wherein the template digital file contains information mapping each extracted constituent shape to the design.
